(19) United States
(12) Patent Application Publication
(10) Pub. No.: US 2021/0036748 A1
(43) Pub. Date: Feb. 4, 2021

(54) METHODS AND APPARATUS FOR CONFIGURING RURAL WIDEBAND MULTI-USER MULTI-INPUT MULTI-OUTPUT ANTENNA ARRAY SYSTEMS

(71) Applicants: Anthony Wayne Brown, Fredericton (CA); Alexander Gordon Bruce Colpitts, Fredericton (CA); Bruce Gordon Colpitts, Fredericton (CA); David Martin Leger, Moncton (CA); Brent Robert Petersen, Hanwell (CA)

(72) Inventors: Anthony Wayne Brown, Fredericton (CA); Alexander Gordon Bruce Colpitts, Fredericton (CA); Bruce Gordon Colpitts, Fredericton (CA); David Martin Leger, Moncton (CA); Brent Robert Petersen, Hanwell (CA)

(21) Appl. No.: 16/937,337

(22) Filed: Jul. 23, 2020

Related U.S. Application Data
(60) Provisional application No. 62/877,690, filed on Jul. 23, 2019.

(51) Int. Cl. H04B 7/0456; H04B 7/06

(52) U.S. Cl. CPC H04B 7/0473; H04B 7/0689; H04B 7/0639; H04B 7/0632

(57) ABSTRACT

An antenna array and method for a multi-user multi-input multi-output antenna array system including at least two receive antennas at a receive area, where the receive antennas are spaced from each other on the order of symbol wavelengths, at least two transmit antennas at a transmit area with at least one transmit antenna spaced from the other at least two transmit antennas on the order of symbol wavelengths, and wherein the antenna array is optimized for multi-user performance for rural areas.

### FIELD

This invention relates to multi-user antennas in general and methods and apparatus for configuring antennas to optimize performance for digital communications in rural areas in particular.

### BACKGROUND

MU-MIMO Systems

A multi-user multi-input multi-output (MU-MIMO) antenna array system makes use of multiple antennas to exploit the difference in channels for each of the antennas. Having multiple antennas some distance apart will result in the channel impulse response of each antenna being different enough to improve the channel quality. This will allow for impairments like random noise, multipath interference, co-channel interference (CCI), and adjacent channel interference (ACI) to be minimized. Multiple antennas will also allow for the creation of a diverse channel that can support multiple independent data streams.

The channel impulse response of a MU-MIMO system can be modeled as an M-by-N matrix for M transmitters and N receivers. If the bandwidth is greater than the coherence bandwidth, then the channel will experience frequency selective fading; in other words, different frequencies will experience vastly different attenuation by the channel. In order to better model the channel for wider bandwidths, the M-by-N matrix becomes an M-by-N-by-O matrix. The Oth dimension represents the fading effects of the channel at the O-points evenly spaced across the signal's bandwidth. An example of the channel impulse response matrix in the time domain for a two-by-two antenna configuration is represented as

$$h ( t ) = ( \begin{matrix}{h}_{11} ( t ) & {h}_{12} ( t ) \\ {h}_{21} ( t ) & {h}_{22} ( t )\end{matrix} ) , \qquad ( Eq . 1 )$$

where h₁₁(t), h₁₂(t), h₂₁(t), and h₂₂(t) are the impulse responses between the antennas shown in FIG. 2 where t is time.

Taking an O-point Fourier transform will lead to the corresponding frequency domain equivalent known as the frequency-dependent channel impulse response are represented as

$$H ( f ) = ( \begin{matrix}{H}_{11} [ k ] & {H}_{12} [ k ] \\ {H}_{21} [ k ] & {H}_{22} [ k ]\end{matrix} ) , \qquad ( Eq . 2 )$$

where H₁₁(f), H₁₂(f), H₂₁(f), and H₂₂(f) are the frequency domain representation of the channel impulse responses between antennas in FIG. 2 and k is the discrete frequency resulting from the O-point Fourier transform.

Performance of a MU-MIMO communication system is generally done by evaluating the capacity of the channel impulse response. The capacity of a frequency selective fading MU-MIMO channel is defined as

$$C = \frac{1}{K} {\sum }_{i = 0}^{K - 1} {log}_{2} ( det [ {I}_{N} + \frac{γ}{M} {H}_{i}^{H} {H}_{i} ] ) \qquad ( Eq . 3 )$$

where Hᵢ is the M-by-N frequency-dependent channel impulse response matrix, superscript H denotes the hermitian transpose, γ is the signal-to-noise ratio (SNR), M is the number of receivers, IM is the M-by-M identity matrix, i is the index of summation, and K is equal to the number of frequency points O [RoPeCo17]. The SNR is defined as

$$γ = \frac{{P}_{S}}{{P}_{N}} \qquad ( Eq . 4 )$$

where P_{S} is the signal power at the receiver and P_{N} is the noise power at the receiver.

From Eq. 3 it can be seen that improvements to the SNR will dramatically improve the capacity of the system. This equation does not include methods for capacity improvement from other means such as channel diversity as it can be difficult to quantify how rich a channel is without actually measuring the channel. Channel diversity will come from objects in the propagation environment between the transmitters and the receivers and the geometry of the channel. Unfortunately, there is no objective way to quantify the channel diversity so channel impulse responses must be simulated or measured.

Rural Propagation Environment

Increasing channel capacity in rural areas has proven to be challenging. For example, antenna arrays that work well in urban environments (such as urban LTE networks) have not been found to be as effective in rural areas. Radio channels in rural environments are often sparse due to the number of strong signaled multipath components being small in number. With the propagation distance being on the order of kilometers, there is a large amount of free-space path loss (FSPL) which in turn will make it very difficult for multipaths to have a useful signal strength by the time they arrive at the receivers. The received signal will likely be a combination of one major reflection and the line-of-sight component (LOS). There may be additional multipaths received due to scattering in the environment but they are likely to be of such a low power level that they are negligible.

When the transmitted signal collides with a scatterer, the signal will be re-transmitted from the scatterer in an isotropic manner, in other words, in all directions. After a signal collides with several scatters, the signal strength will become sufficiently small so that even if it were to make it to the receiver, the signal strength would be negligible or even too small to be detected.

Line of Sight and Ground Reflection

For long-range communication channels it is common for scatterers to attenuate most of the multipath. This will result in two of the stronger paths being the primary signals of interest when evaluating the system; the line-of-sight (LOS) component and the ground-reflection (GR) component. The LOS signal will be launched from a transmit antenna directly to a receive antenna while the ground reflection will launch the signal, have it reflect off the ground, and then be collected by the receive antenna, as shown in FIG. 1.

In FIG. 1 and FIG. 2, the vertical scale is exaggerated for illustrative purposes to show the conventional separation of antennas, which separation is on the order of a half carrier wavelength. For example, for 2.5 GHz to 3.5 GHz networks, a half carrier wavelength separation would represent about a 7 cm separation in the field, which would be too small of a separation to depict if FIG. 1 and FIG. 2 were drawn to scale.

The LOS component of the signal will experience FSPL based on Friis' equation which is defined as

$${P}_{r} = {P}_{t} {G}_{t} {{G}_{r} ( \frac{λ}{4 π d} )}^{2} , \qquad ( Eq . 5 )$$

where Pᵣ is the received power, Pₜ is the transmitted power, Gₜ is the antenna gain of the transmitter, Gᵣ is the antenna gain of the receiver, λ is the carrier wavelength, and d is the distance between the transmitters and receivers. The received signal will also experience some phase change due to the sinusoidal properties of the signal. There will also be some minimal atmospheric attenuation but the value is usually less than 1 (dB) for ranges between 0 and 30 (km) between 2 and 3 (GHz) [ITU].

The GR component of the signal will experience FSPL like the LOS component except there will be slightly more attenuation as the ground reflection will cause the path length to be slightly longer. The additional FSPL experienced by the GR will typically be less than 1 (dB) as the path length distance is very small. The GR component will also experience atmospheric attenuation less than 1 (dB) but will be slightly more than the LOS component as the distance travelled through atmospheric gas is slightly longer.

Once the signal has been launched from the transmit antenna and collides with the ground, one of several things could occur depending on the polarization of the signal and the angle of incidence. Due to communication channels being relatively long range, the assumption will be made that the incident angle will be less than 10 degrees. While the incident angle is less than 10 degrees, the signal that is reflected from the ground will experience negligible absorption by the ground.

It is also of note that the reflection coefficient is −1 for both horizontal and vertical polarization, which means that the reflected signal will experience a phase change of approximately 180 degrees relative to the incident signal [NaJi13][Ba89]. From [NaJi13], it can be seen that the reflection coefficients for horizontally and vertically polarized signals, Γ_{H} and Γ_{V}, are represented as

$${Γ}_{H} = \frac{sin θ - \sqrt{ϵ - {cos}^{2} θ}}{sin θ - \sqrt{ϵ + {cos}^{2} θ}} \qquad ( Eq . 6 )$$

Taking the limit as θ approaches 0 will result in the reflection coefficients for both horizontally and vertically polarized signals approaching a reflection coefficient of −1. This does require the assumption that the earth has a permittivity, ε, that is much higher than that of air. This is a safe assumption as the permittivity of air is approximately 1 while that of earth is approximately 3-30 [ITU2]. Using the small angle approximation it can be seen when 8 is measured in radians

$${Γ}_{V} = \frac{ϵ sin θ - \sqrt{ϵ - {cos}^{2} θ}}{ϵ sin θ - \sqrt{ϵ + {cos}^{2} θ}} \qquad ( Eq . 7 )$$

If the angle of incidence were to be increased past 20 degrees, the small angle approximations start to give way to errors and thus the reflection coefficient starts to change dramatically. This is undesirable as a vertically polarized receive antenna would no longer be able to receive the signal and it may cause interference with any horizontally polarized signals in use.

Antenna Height and Spacing

Increasing the height of an antenna has been found to increase the SNR. [Le98] found that doubling the antenna height will produce an increase of 6 (dB) in the SNR [Le98]. Due to the capacity of a MU-MIMO channel being so heavily weighted on SNR (see Eq. 3), nearly any height increase will cause an improvement to the capacity of the channel. It is therefore conventional wisdom to place antennas as high as possible on transmission and receiving installations. However, this has not been found to increase the rank of antennas in a rural area. For example, it has been found that even when a cluster of antennas is used in a rural area, such as on a rural transmission tower, the rank achieved is not commensurate with the number of antennas in the cluster. For example, a cluster of 16 antennas has been found to only yield a rank of 2 in a rural area.

Typically, the spacing of antennas is treated on the order of carrier wavelengths which is defined as

c=f_{c}λ_{c} (Eq. 10)

where c is the speed of light, f_{c} is the carrier frequency, and λ_{c} is the carrier wavelength.

An alternative method for antenna spacing is on the order of symbol wavelengths [PoCoPe06] which is defined as

c=fₛλₛ (Eq. 11)

where c is the speed of light, fₛ is the symbol rate, and λₛ is the symbol wavelength. The symbol wavelength represents the space that communication symbols occupy in space. [PoCoPe06], however, only spaces antennas horizontally and in an interior space with relatively short transmission distances, a relatively large number of strong signaled multipath components, and no ground reflectance. Having the antennas separated on the order of a carrier wavelength will ensure that they are electromagnetically uncoupled from each other.

Increasing capacity for exterior point-to-point radio links in rural environments dominated by line-of-sight would be desirable.

### SUMMARY

In one implementation, the present disclosure relates to a method of communication and electromagnetic optimization of a MU-MIMO transceiver that makes use of separating antennas on the order of symbol wavelengths to improve the capacity of the channel. Isolation between antennas leads to decorrelation between antennas and results in improved capacity of the channel. Usually the symbol wavelength is an order of magnitude larger (or greater) than the carrier wavelength, which will result in the antennas being electromagnetically and symbolically isolated.

In another implementation, instead of having two antennas at nearly the same location (for example, the same elevation or height), the location of the antennas is altered to produce an increase in spatial diversity from symbolic isolation.

In another implementation, the present disclosure relates to an antenna array for a multi-user multi-input multi-output antenna array system including at least two receive antennas at a receive location, where the receive antennas are spaced or separated from each other on the order of symbol wavelengths, at least two transmit antennas at a transmit location with at least one transmit antenna spaced from the other on the order of symbol wavelengths, and wherein the antenna array is optimized for multi-user performance. In a further implementation, the receive antennas are spaced from each other on the order of symbol wavelengths in the horizontal plane or in the vertical plane or both. In a still further implementation, the transmit antennas are spaced from each other on the order of symbol wavelengths in the horizontal plane or in the vertical plane or both. In yet another implementation, the receive antennas are spaced from each other by a Euclidean distance on the order of 0.1 symbol wavelengths, half symbol wavelengths or symbol wavelengths. In another implementation, the transmit antennas are spaced from each other by a Euclidean distance on the order of symbol wavelengths. In another implementation, the transmit antennas are spaced from each other on the order of half symbol wavelengths. In a further implementation, the number of the receive and transmit antennas is the same and selected from the group consisting of 3, 4, 5, 6, 7 and 8. In a still further implementation, the spacing for the receive and transmit antennas is in the range of 0.1 to 10 symbol wavelengths. In a further implementation, the spacing for receive and transmit antennas is on the order of 0.1 symbol wavelengths or half symbol wavelengths.

In another implementation, the present disclosure relates to an antenna array for a multi-user multi-input multi-output antenna array system for point-to-point rural radio communication including at least two receive antennas at an end user's location, with the receive antennas spaced from each other on the order of symbol wavelengths, at least two transmit antennas on a transmission tower, with the transmit antennas spaced from each other in the vertical plane on the order of symbol wavelengths, wherein, the receive antennas are in line of sight of the transmit antennas, the receive antennas are separated from the transmit antennas on the order of kilometers in a rural area (where the number of strong signaled multipath components are small in number as compared to for a communications network in an urban area), the transmit antennas are connectable to one side of a communications link and the receive antennas are connectable to the other side of a communications link, thereby optimizing the antenna array for multi-user multi-input multi-output performance in the rural area.

In another implementation, the present disclosure relates to a method of spacing receive antennas from each other and transmit antennas from each other by selecting a symbol wavelength separation corresponding to peaks in channel capacity. In a further implementation, the peaks occur at approximately half symbol wavelength separations.

In another implementation, the present disclosure relates to a method of spacing at least two transmit antennas from each other in an antenna array for a multi-user multi-input multi-output antenna array system including placing a first transmit antenna at a first elevation on a transmission tower in a rural area, and placing a second transmit antenna at a second elevation on the transmission tower, where the second elevation is lower than the first elevation by an elevation differential corresponding to a symbol wavelength separation. In a further implementation, the symbol wavelength separation is selected from approximately half symbol wavelength separations. In a still further implementation, the half symbol wavelength separations are selected from the group consisting of about 0.5, about 1.5 and about 2.5 symbol wavelengths.

In another implementation, the present disclosure relates to a method of retrofitting an antenna array including providing at least two transmit antennas on a transmission tower in a rural area for a rural point-to-point radio communications system, and repositioning at least one of the transmit antennas to a lower elevation, where the lower elevation is on the order of half symbol wavelength lower than the elevation of the other at least one transmit antennas. In a further implementation, the half symbol wavelength separations are selected from the group consisting of about 0.5, about 1.5 and about 2.5 symbol wavelengths. In a still further implementation, the at least two transmit antennas comprise a cluster of antennas and the repositioning step comprises repositioning half of the transmit antennas in the cluster. In a still further implementation, the method includes providing at least two receive antennas at an end user's premises where the receive antennas are separated in the vertical plane by a separation on the order of symbol wavelengths. In a still further implementation, the receive antennas are separated on the order of half symbol wavelengths. In a still further implementation, the half symbol wavelength separations are selected from the group consisting of about 0.5, about 1.5 and about 2.5 symbol wavelengths.

### BRIEF DESCRIPTION OF THE DRAWINGS

Embodiments of the present invention will now be described, by way of example only, with reference to the accompanying drawings and figures, wherein:

FIG. 1 is a depiction of a prior art two-by-two MU-MIMO antenna arrangement demonstrating the line-of-sight and ground reflection component of a signal received at one receiving antenna that was sent by one transmit antenna;

FIG. 2 is a depiction of a prior art two-by-two MU-MIMO antenna arrangement demonstrating that each receive antenna receives a signal from all transmit antennas;

FIG. 3 is a depiction of a configuration of two transmit and two receive antennas according to an embodiment of the present invention;

FIGS. 4a-4c are top, front and side views, respectively, of a configuration of a two-by-two MU-MIMO antenna arrangement, located at a home, according to an embodiment of the present invention. The antenna structure at the tower will have the same basic configuration as at the home;

FIG. 5 is a graph of Transmit Antenna Altitude Variation, BW=80 MHz, Geometric Simulation;

FIG. 6 is a diagram of antenna placement for anechoic chamber measurements;

FIG. 7 is a graph of capacity with and without antenna separation measured in anechoic chamber configured to emulate only LOS and GR signals;

FIG. 8 is a flow diagram of a method according to an embodiment of the present invention;

FIG. 9 is a flow diagram of a method according to another embodiment of the present invention;

FIG. 10 depicts a prior art transmission tower with a cluster of two transmit antennas; and

FIG. 11 depicts the tower of FIG. 10 retrofitted in accordance with a method and antenna array configuration of the present invention.

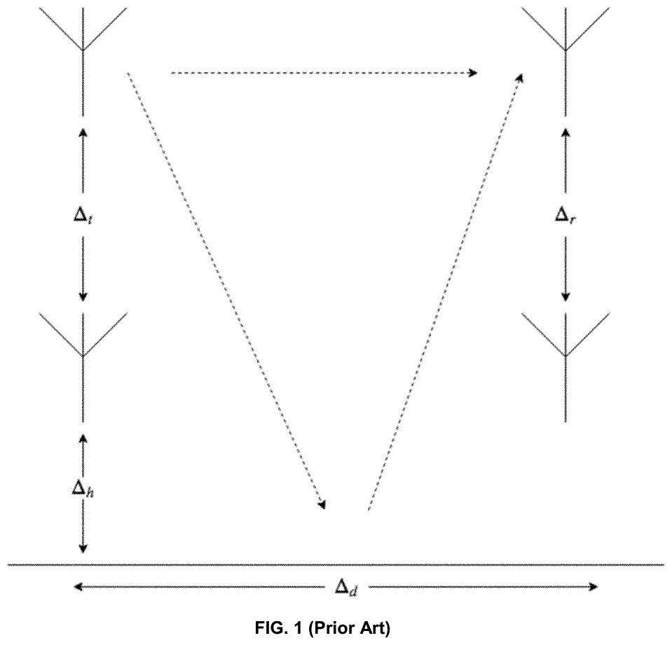

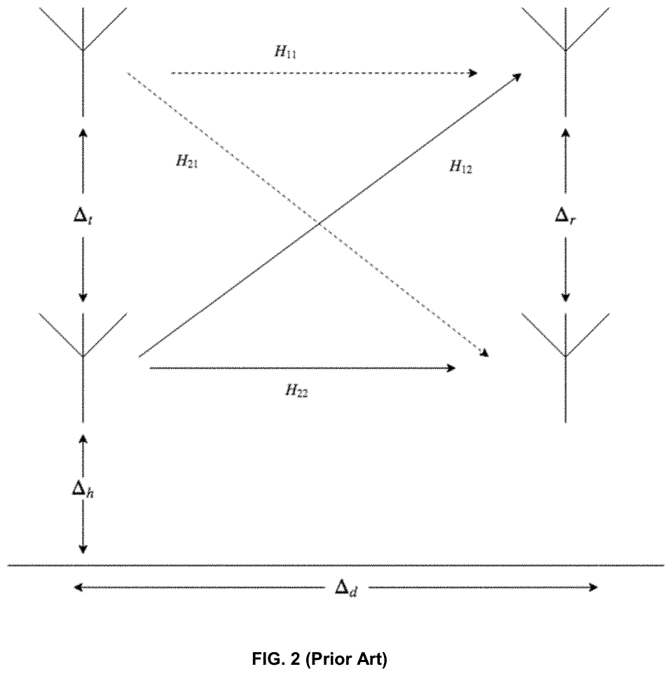

### DETAILED DESCRIPTION OF THE INVENTION

In this application the following definitions are used.

“Antenna” means a transducer that receives and transmits electromagnetic waves.

“Antenna array” means a group of antennas positioned in a specified spatial pattern.

“Antenna structure” means a physical structure holding the antennas in a desired array.

“On the order of symbol wavelengths” means a relatively large separation distance of at least 0.1 symbol wavelengths.

“Optimized” or “optimization” means when a system is referred to as being optimized or to have optimization applied to it, it will be understood by those skilled in the art that optimization is not limited to a maximum optimization and can include improvements of varying degrees over prior art apparatus, systems and methods.

“Scatterer” means an object that will cause the electromagnetic wave to be redirected in all directions.

“Symbol wavelength” means the distance obtained by dividing the speed of light by the one-sided passband frequency allocation used by the radio signals.

MU-MIMO Configuration

The performance of antenna placements can be evaluated through simulation and measurements. In one embodiment, the propagation environment for this invention is one that has few scatterers. The primary received signal components are the line-of-sight (LOS) component and the ground reflected component (GR). The LOS components are the direct path from transmit antennas to receive antennas. The GR components are the path from transmit antennas to the ground and then to receive antennas.

In one embodiment, the transmit and receive antennas will be in at least a two-by-two arrangement which is to say there will be a minimum of two transmit antennas and two receive antennas. The separation of antennas change the environment that the electromagnetic signals pass through, thus improving the richness of the channel and the capacity. The spacing also decreases the correlation of the received signals, which in turn also increases the capacity of a MU-MIMO system.

In another embodiment, the present invention relates to an optimization problem, as reducing the height or elevation of one of the antennas (for example, from a conventional height) by too much results in SNR losses that cause the capacity to be reduced by more than the spatial diversity will cause as gains. Varying the height also causes the distance travelled by the LOS and GR components to change. This change causes a phase change at the receive antennas and may cause a major reduction in SNR, which will then cause a reduction in capacity. Reducing the height of one antenna from a conventional antenna height (which, for example, may be ‘as high as possible’) by a half a symbol wavelength can cause performance increases approaching N-fold, where N is the number of receive antennas.

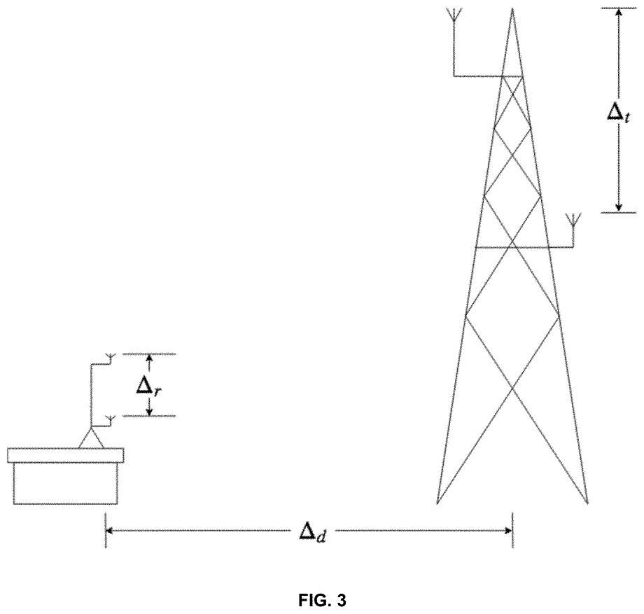

With reference to FIG. 3, in one embodiment, separation of receive antennas (depicted as [symbol] and separated by spacing Δᵣ in FIG. 3) in the z-plane (vertical plane) only is useful since most home equipment and towers easily accommodate vertical separation. In other embodiments, the receive antennas can also be separated in the x and/or y-plane, but separation in the x and y planes may require more equipment such as extra polls, tower extensions, or additional software processing. In FIG. 3, the transmit antennas (depicted as [symbol] ) are separated by spacing Δₜ in the z-plane, and are also separated in the horizontal plane. In another embodiment, the transmit antennas can be separated only in the z-plane. In a further embodiment, the transmit antennas can be separated in the y-plane. In a rural area, the receive and transmit antennas are separated from each other by distance Δ_{d}, which is on the order of kilometers.

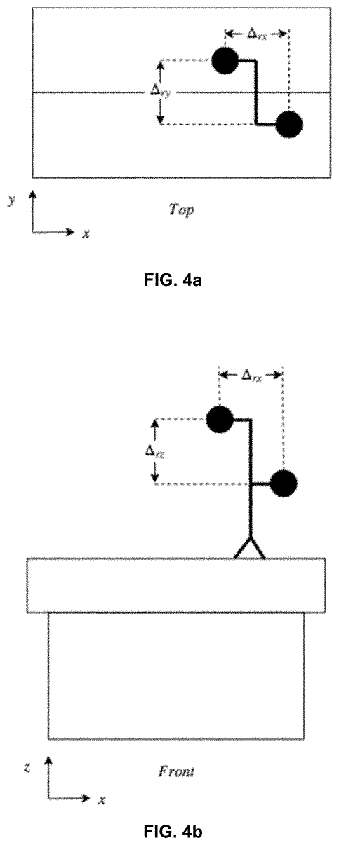

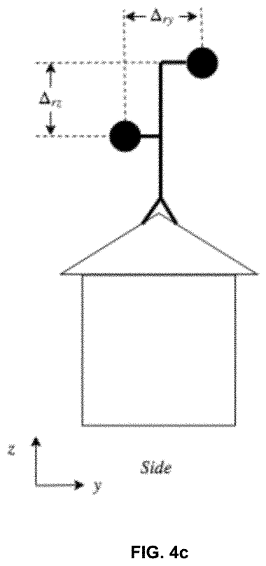

In one embodiment, antennas, as depicted as solid black circles in FIGS. 4a-4c, need not only be separated in the z-plane as depicted in FIG. 4b and FIG. 4c. Antennas can also be separated in the x and y-plane as depicted in FIG. 4a.

Antennas according to embodiments of the present invention do not need to use a specific polarization, but for any vertically polarized signals, the angle of incidence must be sufficiently small to ensure that the reflected signals are not horizontally polarized. If the vertically polarized signal does become horizontally polarized, the signal received by the vertically polarized receive antenna may not be strong enough to properly use the channel.

Geometric Simulation Overview

A simulation was created using Python with some basic assumptions. The channel was assumed to have:

a SNR of 24 (dB) added in baseband;
Passband to baseband modulators use coefficients of √2 to make baseband power equal to the passband power;
no noise due to high SNR;
only a LOS and a GR component from each transmitting antenna;
no scattering received with a power level sufficiently high to be measurable beyond the ground reflections; and
the relative permittivity of air is much less than that of the ground.

The simulation parameters are further set out in Table 1.

TABLE 1

| Simulation Parameter | Value | |
|---|---|---|
| Centre Carrier Frequency | 2.4 | (GHz) |
| Baseband Bandwidth | 56 | (MHz) |
| SNR | 24 | (dB) |
| Ground Reflection Coefficient | 1 | |
| Number of Transmit Antennas | 2 | |
| Number of Receive Antennas | 2 | |
| Receive Antenna Height | 16, 13.5 | (m) |
| Initial Tower Height | 90 | (m) |

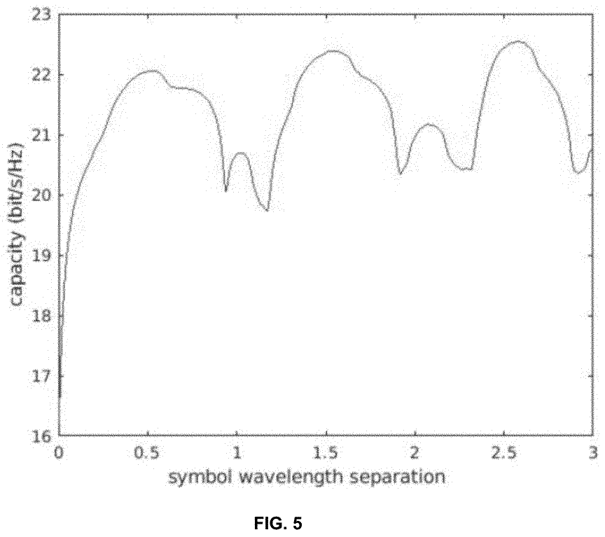

FIG. 5 was generated using a geometric simulation taking the assumptions listed in Table 1 into account. The receiver antenna heights were kept to 13.5 (m) and 16 (m) respectively, while one of the transmit antennas was held at a constant 90 (m), while the altitude of the other transmit antenna was reduced by the symbol wavelength distances shown on the horizontal axis in FIG. 5. Peaks in channel capacity were observed at 0.5, 1.5 and 2.5 symbol wavelength separations. For example, for a conventional LTE network with a 20 MHz bandwidth, a vertical spacing of 0.5 symbol wavelengths corresponds to about 7.5 (m) as calculated using Eq. 11. Reducing the elevation of a transmit antenna on a transmission tower in a rural area by 7.5 (m) is not only significant, it runs counter to the teaching in [Le98] that the higher an antenna, the better.

While FIG. 5 was generated for a system having two transmit antennas and two receive antennas (a 2×2 or rank 2 system), similar results were obtained in terms of MU-MIMO system capacity changes due to increases in the separation of transmit antennas for 3×3 or rank 3 and 4×4 or rank 4 systems. Similar results were obtained in simulations where the separation of the receive antennas in rank 2, rank 3, and rank 4 systems was increased from 0 symbol wavelengths to 3 symbol wavelengths.

Adding noise to the simulation was done by measuring the power level of the signal and then adding in white Gaussian noise at a power level of 30 (dB) less than the measured value. The noise power level was calculated based on the baseband signal. The assumption was made that the baseband and passband power are the same. This makes the modulation coefficients used in conversion from passband to baseband be \sqrt{2}.

The periodicity of the capacity is expected by the signals themselves being periodic. Depending on the configuration, the electromagnetic waves will cause different amounts of constructive and destructive interference as they oscillate. This difference in interference amounts will cause an SNR change, which will in turn cause the capacity to change.

It is also of note that this simulation is the worst-case scenario for a propagation environment. There will likely be more multipath present in most communication channels. These improvements can be seen in the worst multipath scenario, which would lend itself to the fact that a channel with better multipath would experience even more dramatic improvement.

Channel Measurements

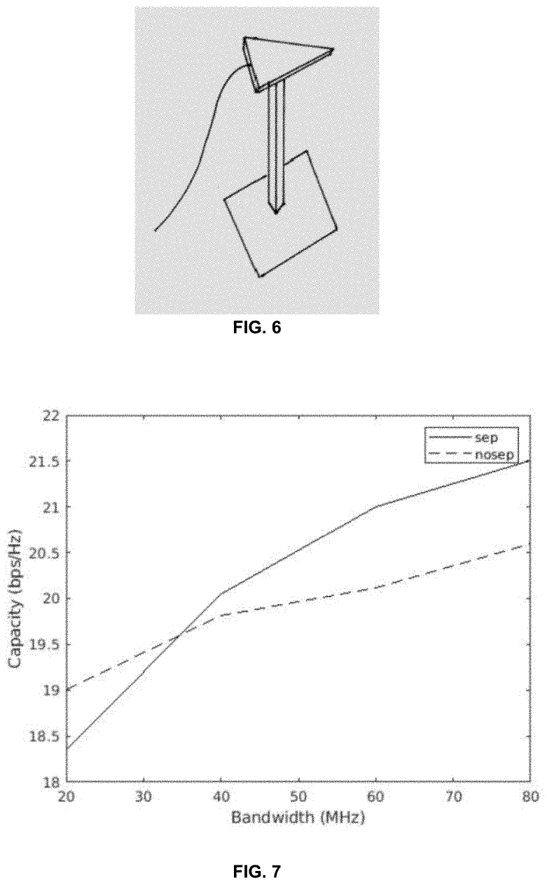

Measurements were done in an anechoic chamber using four HyperLog 7060 antennas (two transmitters, two receivers) and an Agilent N5242A VNA. Antennas were measured at two different configurations, one with the antennas stacked directly on top of each other and one with the antennas separated by 60 (cm). Referring to FIG. 6, the antennas were configured in a manner that the plane formed by the floor and the antenna's largest surface would be parallel. The bandwidth of the channel was varied to increase the distance between the two antennas with regard to symbol wavelengths.

FIG. 7 shows that as the effective separation of the antennas increases, the capacity of the channel will increase at a greater rate in the case of the antennas with separation (see the “sep” line) than that of the antennas with no separation (see the “nosep” line).

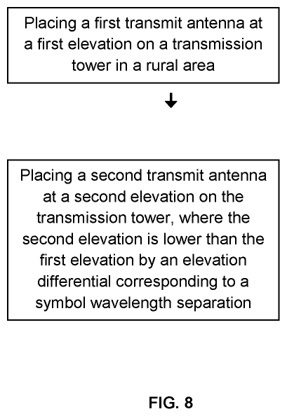

Referring to FIG. 8, in another embodiment, the present invention relates to a method of spacing at least two transmit antennas from each other in an antenna array for a multi-user multi-input multi-output antenna array system including placing a first transmit antenna at a first elevation on a transmission tower in a rural area, and placing a second transmit antenna at a second elevation on the transmission tower, where the second elevation is lower than the first elevation by an elevation differential corresponding to a symbol wavelength separation. In another embodiment, the height of the transmission tower can be reduced when transmit antennas are separated according to embodiments of the present invention because the separated antennas do not have to be placed at an elevation as high as the conventional placement of a single antenna or single cluster of antennas.

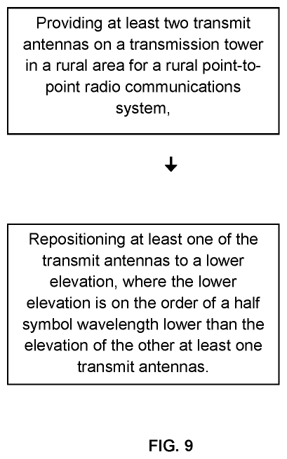

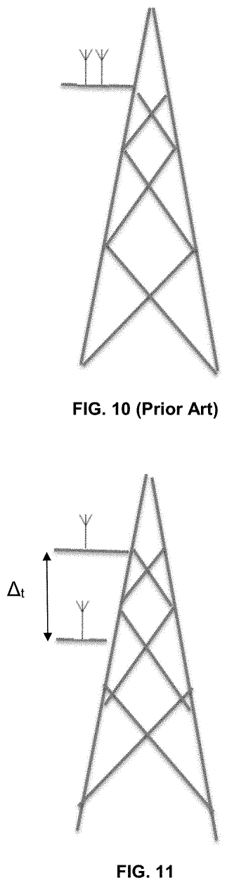

Referring to FIG. 9, FIG. 10 and FIG. 11, in another embodiment, the present invention relates to a method of retrofitting an antenna array including providing at least two transmit antennas on a transmission tower in a rural area for a rural point-to-point radio communications system, and repositioning at least one of the transmit antennas to a lower elevation, where the lower elevation is on the order of a half symbol wavelength lower than the elevation of the other at least one transmit antennas. FIG. 10 depicts a conventional transmission tower with a cluster of two transmit antennas. FIG. 11 depicts the tower of FIG. 10 which has been retrofitted to reposition one of the transmit antennas to a lower elevation. Whereas the transmit antennas in FIG. 10 are at the same elevation, the transmit antennas in FIG. 11 are separated by spacing Δₜ in the z-plane. Similarly, where there is typically only one antenna or antenna cluster on a tower or mast at an end user's premises (such as a home or cottage) in a conventional receive antenna set-up, a second antenna or antenna cluster can be added to the same tower or mast separated by spacing Δᵣ in the z-plane, such as depicted in FIG. 3.

### REFERENCES

[RoPeCo17] C. D. Rouse, B. R. Petersen, and B. G. Colpitts, “Characterising an In-Room MIMO System Employing Elevation-Directional Access Point Antennas,” Wireless Personal Communications, vol. 96, no. 3, pp. 3889-3905, October 2017.
[NaJi13] N. Najibi and S. Jin, “Physical Reflectivity and Polarization Characteristics for Snow and Ice-Covered Surfaces Interacting with GPS Signals,” Remote Sensing, vol. 5, no. 8, pp. 4006-4030, August 2013.
[PoCoPe06] V. V. S. N. Polu, B. G. Colpitts, and B. R. Petersen, “Symbol-wavelength MMSE gain in a multi-antenna UWB system,” in Proceedings of the 4th Annual Communications Networks and Services Research Conference (CNSR 2006), Moncton, NB, Canada, 2006, vol. 1, pp. 95-99.
[Le98] W. Y. C. Lee, Mobile Communications Engineering, 2nd ed. New York, N.Y., USA: The McGraw-Hill Companies, Inc., 1998.
[Ba89] C. A. Balanis, Advanced engineering electromagnetics. New York: Wiley, 1989.
[ITU] International Telecommunication Union, “Attenuation by atmospheric gases,” no. ITU-R P.676-10, p. 25.
[ITU2] International Telecommunication Union, “Electrical characteristics of the surface of the Earth,” no. ITU-R P.527-4, p. 21.

We claim:

1. An antenna array for a multi-user multi-input multi-output antenna array system for point-to-point rural radio communication comprising:
at least two receive antennas at an end user's location, with the receive antennas spaced from each other on the order of symbol wavelengths,
at least two transmit antennas on a transmission tower, with the transmit antennas spaced from each other in the vertical plane on the order of symbol wavelengths,
wherein,
the receive antennas are in line of sight of the transmit antennas,
the receive antennas are separated from the transmit antennas on the order of kilometers in a rural area,
the transmit antennas are connectable to one side of a communications link and,
the receive antennas are connectable to the other side of a communications link,
thereby optimizing the antenna array for multi-user multi-input multi-output performance in the rural area.

2. The antenna array of claim 1, wherein the receive antennas are spaced from each other on the order of symbol wavelengths in the vertical plane.

3. The antenna array of claim 1, wherein the receive antennas are spaced from each other by a Euclidean distance on the order of symbol wavelengths.

4. The antenna array of claim 1, wherein the transmit antennas are spaced from each other by a Euclidean distance on the order of symbol wavelengths.

5. The antenna array of claim 1, wherein the transmit antennas are spaced from each other on the order of half symbol wavelengths.

6. The antenna array of claim 5, wherein the half symbol wavelengths are selected from the group consisting of about 0.5, about 1.5 and about 2.5 symbol wavelengths.

7. The antenna array of claim 1, wherein the number of the receive and transmit antennas is the same and selected from the group consisting of 3, 4, 5, 6, 7 and 8.

8. The antenna array of claim 1, wherein the spacing for the receive and transmit antennas is in the range of 0.1 to 10 symbol wavelengths.

9. A method of spacing at least two transmit antennas from each other in an antenna array for a multi-user multi-input multi-output antenna array system comprising:
placing a first transmit antenna at a first elevation on a transmission tower in a rural area, and
placing a second transmit antenna at a second elevation on the transmission tower, where the second elevation is lower than the first elevation by an elevation differential corresponding to a symbol wavelength separation.

10. The method of claim 9, wherein the symbol wavelength separation is selected from approximately half symbol wavelength separations.

11. The method of claim 10, wherein the half symbol wavelength separations are selected from the group consisting of about 0.5, about 1.5 and about 2.5 symbol wavelengths.

12. A method of retrofitting an antenna array comprising:
providing at least two transmit antennas on a transmission tower in a rural area for a rural point-to-point radio communications system, and:
repositioning at least one of the transmit antennas to a lower elevation, where the lower elevation is on the order of half symbol wavelength lower than the elevation of the other at least one transmit antennas.

13. The method of claim 12, wherein the half symbol wavelength separations are selected from the group consisting of about 0.5, about 1.5 and about 2.5 symbol wavelengths.

14. The method of claim 13, wherein the at least two transmit antennas comprise a cluster of antennas and the repositioning step comprises repositioning half of the transmit antennas in the cluster.

15. The method of claim 12, further comprising providing at least two receive antennas at an end user's premises where the receive antennas are separated in the vertical plane by a separation on the order of symbol wavelengths.

16. The method of claim 15, wherein the antennas are separated on the order of half symbol wavelengths.

17. The method of claim 16, wherein the half symbol wavelength separations are selected from the group consisting of about 0.5, about 1.5 and about 2.5 symbol wavelengths.
